(19) United States
(12) Patent Application Publication
(10) Pub. No.: US 2024/0149874 A1
(43) Pub. Date: May 9, 2024

(54) DRIVING SUPPORT APPARATUS

(71) Applicant: TOYOTA JIDOSHA KABUSHIKI KAISHA, Toyota-shi (JP)

(72) Inventors: Hiroshi OYAGI, Kyoto-shi (JP); Hirokazu ITO, Sunto-gun (JP); Shinya SHIRATORI, Susono-shi (JP); Norimi ASAHARA, Numazu-shi (JP)

(73) Assignee: TOYOTA JIDOSHA KABUSHIKI KAISHA, Toyota-shi (JP)

(21) Appl. No.: 18/494,845

(22) Filed: Oct. 26, 2023

(30) Foreign Application Priority Data
Nov. 8, 2022 (JP) 2022-179050

(51) Int. Cl. B60W 30/14; B60W 60/00

(52) U.S. Cl. CPC B60W 30/143; B60W 60/001; B60W 2540/22; B60W 2540/221; B60W 2540/225

(57) ABSTRACT

A driving support apparatus includes a processor configured to: obtain biometric information for at least one occupant on a vehicle; estimate emotion of the occupant based on the biological information; control acceleration of the vehicle based on the estimated emotion of the occupant.

The present application claims priority to and incorporates by reference the entire contents of Japanese Patent Application No. 2022-179050 filed in Japan on Nov. 8, 2022.

### BACKGROUND

The present disclosure relates to a driving support apparatus.

JP 4-345536 discloses a technique capable of traveling at a constant speed while detecting a preceding vehicle while following the preceding vehicle. In this technique, when it becomes impossible to detect the preceding vehicle while traveling at a constant speed while following the preceding vehicle, acceleration is not performed until there is an instruction of acceleration from the driver, or accelerated at a small acceleration.

### SUMMARY

However, in JP-A-4-345536, only the timing to accelerate is determined, not considered to the comfort of the occupant due to acceleration, there is room for improvement.

There is a need for a driving support apparatus capable of increasing the comfort of the user.

According to one aspect of the present disclosure, there is provided a driving support apparatus including a processor configured to: obtain biometric information for at least one occupant on a vehicle; estimate emotion of the occupant based on the biological information; control acceleration of the vehicle based on the estimated emotion of the occupant.

### BRIEF DESCRIPTION OF THE DRAWINGS

FIG. 1 is a block diagram showing a functional configuration of a vehicle according to a first embodiment;

FIG. 2 is a diagram schematically showing an outline of the flow of information in each part of the driving support apparatus according to the first embodiment;

FIG. 3 is a flowchart showing an outline of a process performed by the driving support apparatus according to the first embodiment;

FIG. 4 is a flowchart showing an outline of a process performed by the driving support apparatus according to a second embodiment;

FIG. 5 is a flowchart showing an outline of a process performed by the driving support apparatus according to a third embodiment;

FIG. 6 is a diagram showing a relationship between acceleration and time of the vehicle according to the third embodiment;

FIG. 7 is a flowchart showing an outline of a process performed by the driving support apparatus according to a fourth embodiment;

FIG. 8 is a diagram showing a relationship between acceleration and time of the vehicle according to the fourth embodiment; and

FIG. 9 is a diagram showing a relationship between acceleration and time of the vehicle according to the fourth embodiment.

### DETAILED DESCRIPTION

Hereinafter, a vehicle including a driving support apparatus according to an embodiment of the present disclosure will be described with reference to the drawings. The present disclosure is not limited to the following embodiments. In the following, the same portions will be described with the same reference numerals.

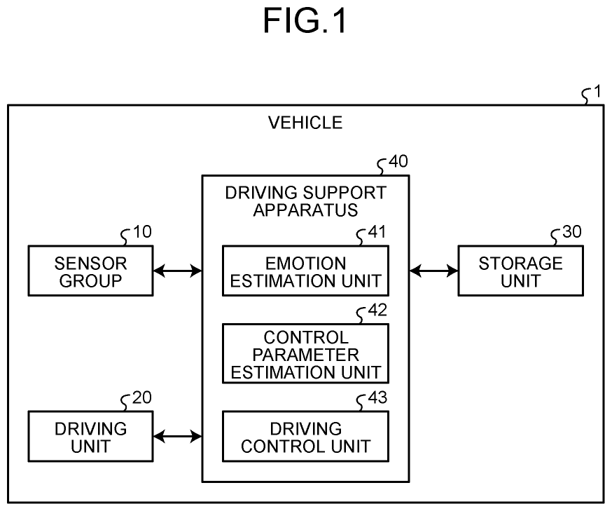

FIG. 1 is a block diagram showing a functional configuration of a vehicle according to the first embodiment. A vehicle 1 illustrated in FIG. 1 may be a hybrid electric vehicle (HEV), a plug-in hybrid electric vehicle (PHEV), a battery electric vehicle (BEV), a fuel cell electric vehicle (FCEV) or the likes. Moreover, the vehicle 1 may be capable of cruise control in which the vehicle may automatically maintain a constant speed while following a vehicle ahead at a predetermined inter-vehicle distance. The vehicle 1 includes a sensor group 10, a drive unit 20, a storage unit 30 and a driving support apparatus 40.

The sensor group 10 is configured using a temperature sensor, a pulse sensor, an imaging device, an acceleration sensor and a gyro sensor or the like. The sensor group 10 detects various information about the vehicle 1, and outputs the detection information to the driving support apparatus 40. The detection information includes biological information of the occupant in the vehicle 1, image information obtained by imaging the occupant, acceleration of the vehicle 1 and the gaze information of the occupant, and the like. Moreover, biological information includes the pulse of the occupant, the presence or absence of perspiration and body temperature and the like.

The drive unit 20 is implemented using an engine, a motor or the like. The driving unit 20 accelerates the vehicle 1 by driving under the control of the driving support apparatus 40.

The storage unit 30 is implemented using a read only memory (ROM), a random access memory (RAM), a solid state drive (SSD), and a hard disk drive (HDD). The storage unit 30 stores an operating system (OS), various programs, various tables and various databases. The storage unit 30 may store the estimation result of the emotion estimation unit 41 and the control parameter estimation unit 42 described later. The storage unit 30 may store the machine-learned model (trained model) used in the emotion estimation unit 41 and the control parameter estimation unit 42 described later.

The driving support apparatus 40 is implemented using a processor having hardware. The hardware includes, for example, a memory, a central processing unit (CPU), a digital signal processor (DSP), a field-programmable gate array (FPGA) and a graphics processing unit (GPU). The driving support apparatus 40 controls the respective units constituting the vehicle 1. The driving support apparatus 40 loads the program stored in the storage unit 30 into the work area of the memory and executes the program, and controls each configuration unit and the like through the execution of the program to realize a function that meets a predetermined purpose. The driving support apparatus 40 includes an emotion estimation unit 41, a control parameter estimation unit 42 and a driving control unit 43.

The emotion estimation unit 41 acquires biometric information of at least one occupant on the vehicle 1 and estimates the emotion of the occupant based on the biometric information. Specifically, the emotion estimation unit 41 estimates the emotion of the occupant on the vehicle 1 based on the learned model or the rule which is previously learned by the machine learning. When the learned model is used in the emotion estimation unit 41, the input data are the biometric information of the occupant, the acceleration, and the image data of the occupant, which are acquired from the sensor group, and the line-of-sight information of the occupant. Then, the output data is the emotion of the occupant. Here, the biological state is, for example, the heart rate of the occupant measured by the sensor group 10, the presence or absence of perspiration and body temperature and the like. The image data of the occupant includes the expression information of the occupant captured by the sensor group 10, the state information of the occupant and the line-of-sight information of the occupant. The expression information is a numerical value of the degree of coincidence based on the occupant's face and a predetermined pattern (e.g., a smiling face). Further, the state information is information of the detection result of detecting either the awake state and the sleeping state of the occupant based on the lid of the occupant. Moreover, the emotion of the occupant is either comfortable, normal or unpleasant.

In the first embodiment, although the emotion estimation unit 41 outputs the emotion of the occupant in three stages, it is sufficient to have at least two stages of comfort and discomfort without being limited thereto. Of course, the emotion estimating unit 41 may output the emotion of the occupant in three or more stages, for example, “comfort”, “slightly comfortable”, “normal”, “slightly uncomfortable” and “unpleasant” in five stages. The emotion estimating unit 41 outputs the emotion of the occupant in three stages, without being limited thereto, for example, may output a numerical value (probability) of the discomfort of the occupant. Incidentally, the numerical value of the discomfort, for example, indicates a numerical index indicating the comfort or discomfort. Moreover, the probability of discomfort indicates the probability for a particular emotion indicating comfort or discomfort.

Further, a technique of constructing a learned model used in the emotion estimating unit 41 is not particularly limited, and various machine learning techniques such as a deep learning using a neural network, a support vector machine, a decision tree, a simple Bayes, and a k neighborhood method can be used.

The control parameter estimation unit 42 estimates the control parameter for controlling the acceleration of the vehicle 1 based on the estimation result of the occupant estimated by the emotion estimation unit 41. The control parameter estimating unit 42 estimates the control parameter for controlling the acceleration of the vehicle 1 based on the emotion of the occupant based on the learned model or the rule previously learned by the machine learning. When the learned model is used in the control parameter estimation unit 42, the input data is an estimation result of the emotion of the occupant. The output data is a control parameter of the driving unit 20 for controlling the acceleration of the vehicle 1. For example, the control parameters are torque and motor or engine speed, etc. Further, a technique of constructing a learned model used in the control parameter estimator 42 is not particularly limited, and various machine learning techniques such as a deep learning using a neural network, a support vector machine, a decision tree, a simple Bayesian, and a k-neighborhood method can be used.

The driving control unit 43 controls the acceleration of the vehicle 1 by driving the driving unit 20 based on the control parameter input from the control parameter estimating unit 42.

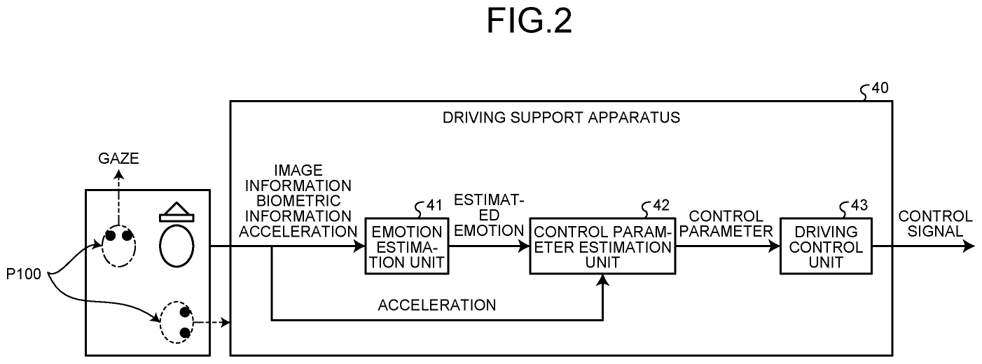

Next, an overview of the flow of information in each part of the driving support apparatus 40. FIG. 2 is a diagram schematically showing an outline of the flow of information in each part of the driving support apparatus 40.

As illustrated in FIG. 2, the emotion estimation unit 41 acquires the biometric data of at least one occupant P100 on the vehicle 1 and the current acceleration of the vehicle 1 from the sensor group 10. Then, the emotion estimation unit 41 estimates the emotion of the occupant based on the biometric information of the occupant P100 acquired from the sensor group 10.

Subsequently, the control parameter estimation unit 42 estimates the control parameter for controlling the acceleration of the vehicle 1 based on the emotion estimation result of the occupant P100 estimated by the emotion estimation unit 41 and the acceleration of the vehicle 1 acquired from the sensor group 10.

Thereafter, the driving control unit 43 generates a control signal of the drive unit 20 for controlling the acceleration of the vehicle 1 based on the control parameter input from the control parameter estimating unit 42, and outputs the control signal to the drive unit 20.

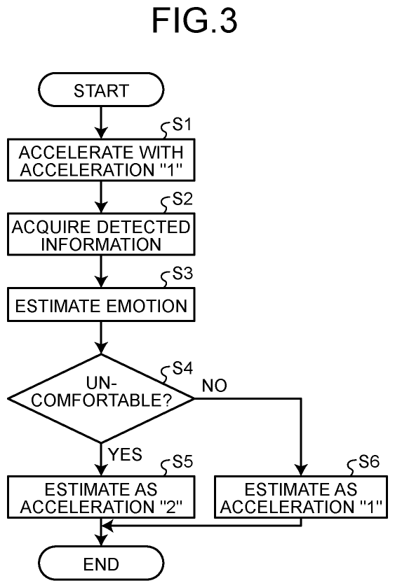

Next, a process that the driving support apparatus 40 executes is explained. FIG. 3 is a flowchart showing an outline of the process performed by the driving support apparatus 40. In the following description, the processing that the driving support apparatus 40 executes at each predetermined timing will be described when the vehicle 1 runs on the cruise control which maintains the speed at a constant automatically while following a predetermined distance between vehicles in front of the vehicle. Further, the predetermined timing-by-timing is, for example, every minute or every time the vehicle 1 travels 100 m.

As illustrated in FIG. 3, first, the driving control unit 43 accelerates the vehicle 1 with the acceleration “1” by driving the driving unit 20 (Step S1).

Subsequently, the emotion estimation unit 41 acquires the detected information including the biological information of at least one occupant P100 on the vehicle 1 and the current acceleration of the vehicle 1 from the sensor group 10 (Step S2).

Thereafter, the emotion estimation unit 41 estimates the emotion of the occupant based on the biological information of the occupant included in the detected information acquired from the sensor group 10 (Step S3).

Subsequently, when the emotion estimating unit 41 estimates that the emotion of the occupant is uncomfortable (Step S4: Yes), the control parameter estimating unit 42 estimates the acceleration of the vehicle 1 as the acceleration “2” (Step S5). Specifically, the control parameter estimating unit 42 estimates the control parameter corresponding to the acceleration “2” which is smaller than the acceleration “1” in which the emotion of the occupant becomes comfortable. The control parameters are output from the control parameter estimation unit 42 to the driving control unit 43. Here, the acceleration “2” is a value smaller than the value of the acceleration “1”. In this case, the driving control unit 43 controls the drive unit 20 according to the control parameters input from the control parameter estimator 42. After Step S5, the driving support apparatus 40 ends the process.

In the Step S4, when the emotion estimation unit 41 determines that the emotion of the occupant is not uncomfortable (Step S4: No), the control parameter estimation unit 42 estimates the acceleration of the vehicle 1 as the acceleration “1” (Step S6). Specifically, the control parameter estimating unit 42 estimates the control parameter for maintaining the acceleration “1” since the acceleration of the current vehicle 1 is acceleration “1” and the emotion of the occupant is comfortable. The control parameters are output from the control parameter estimation unit 42 to the driving control unit 43. In this case, the driving control unit 43 controls the drive unit 20 according to the control parameters input from the control parameter estimator 42. After Step S6, the driving support apparatus 40 ends the process.

According to the first embodiment described above, since the control parameter estimation unit 42 estimates the control parameter for controlling the acceleration of the vehicle 1 based on the emotion of the occupant estimated by the emotion estimation unit 41, it is possible to increase the comfort of the user.

Next, the second embodiment will be described. In the second embodiment, the acceleration of the vehicle 1 is estimated by further using the gaze information related to a gaze (a line of the sight) of the occupant included in the detection information. Incidentally, the driving support apparatus according to the second embodiment has the same configuration as the driving support apparatus 40 according to the first embodiment. In the following, the processing performed by the driving support apparatus 40 according to the second embodiment is explained.

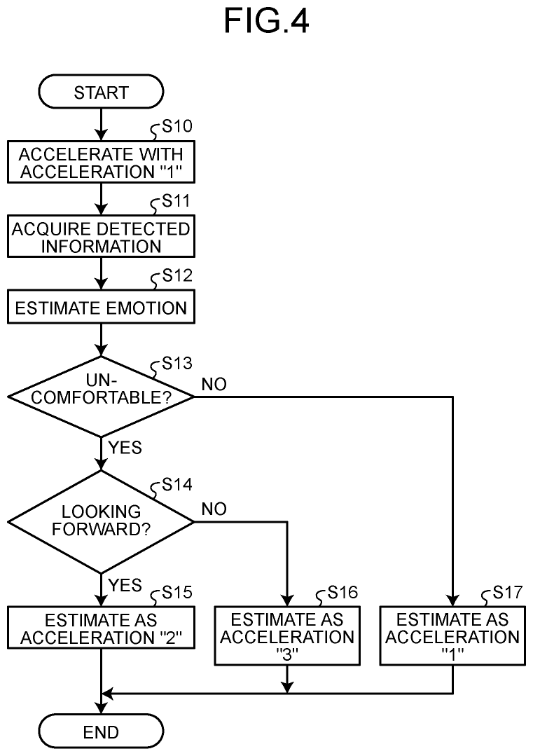

FIG. 4 is a flowchart showing an outline of the process performed by the driving support apparatus 40 according to the second embodiment. In the following description, the processing that the driving support apparatus 40 executes at each predetermined timing will be described when the vehicle 1 runs on the cruise control which maintains the speed at a constant automatically while following a predetermined distance between vehicles in front of the vehicle. Moreover, in FIG. 4, Step S10 to Step S12 correspond to Step S1 to Step S3 in FIG. 3, respectively.

First, a case where it is estimated in Step S13 that the emotion estimating unit 41 estimates that the emotion of the occupant is uncomfortable (Step S13: Yes) and that the occupant looks forward in the vehicle 1 in the traveling direction (Step S14: Yes) will be described. In this case, the control parameter estimating unit 42 estimates the acceleration of the vehicle 1 as the acceleration “2” (Step S15). Specifically, the control parameter estimating unit 42 estimates the control parameter corresponding to the acceleration “2” which is smaller than the acceleration “1”, in which the emotion of the occupant becomes comfortable, even when the occupant is looking forward. The control parameters are output from the control parameter estimation unit 42 to the driving control unit 43. The driving control unit 43 accelerates the acceleration of the vehicle 1 to the acceleration “2” by controlling the driving unit 20 according to the control parameter input from the control parameter estimating unit 42. After Step S15, the driving support apparatus 40 ends the process.

Next, a case where the emotion estimating unit 41 estimates in Step S13 that the emotion of the occupant is uncomfortable (Step S13: Yes) and that the occupant is not looking forward of the vehicle 1 in the running direction (Step S14: No) will be described. In this case, the control parameter estimating unit 42 estimates the acceleration of the vehicle 1 as the acceleration “3” (Step S16). Specifically, the control parameter estimating unit 42 estimates the control parameter corresponding to the acceleration “3” which is smaller than the acceleration “2”, in which the emotion of the occupant becomes comfortable, even in a state in which the occupant looks at the side, for example, in a state in which the face is directed in a lateral direction perpendicular to the running direction of the vehicle 1. That is, the magnitude of the acceleration is represented by the acceleration “1”, the acceleration “2” and acceleration “3” in this order. The control parameters are output from the control parameter estimation unit 42 to the driving control unit 43. The driving control unit 43 accelerates the acceleration of the vehicle 1 to the acceleration “3” by controlling the driving unit 20 according to the control parameter input from the control parameter estimating unit 42. After Step S16, the driving support apparatus 40 ends the process.

Next, in the Step S13, it will be described when the emotion estimation unit 41 estimates that the emotion of the occupant is not uncomfortable (Step S13: No). In this case, the control parameter estimating unit 42 estimates the acceleration “1” of the vehicle 1 (Step S17). Specifically, the control parameter estimation unit 42 outputs a control parameter corresponding to the current acceleration “1” to the driving control unit 43 because the emotion of the occupant is comfortable. After Step S17, the driving support apparatus 40 ends the process.

According to the second embodiment described above, since the control parameter estimating unit 42 estimates the control parameter for controlling the acceleration of the vehicle 1 further using the direction of the occupant's face estimated by the emotion estimating unit 41, the comfort of the user can be further enhanced.

Next, a third embodiment is explained. In the third embodiment, the acceleration of the vehicle 1 is further adjusted using the arousal state of the occupant based on the biological information and the image information. The configuration of the driving support apparatus according to the third embodiment is the same as the driving support apparatus 40 according to the first embodiment. In the following, the processing performed by the driving support apparatus according to the third embodiment is described.

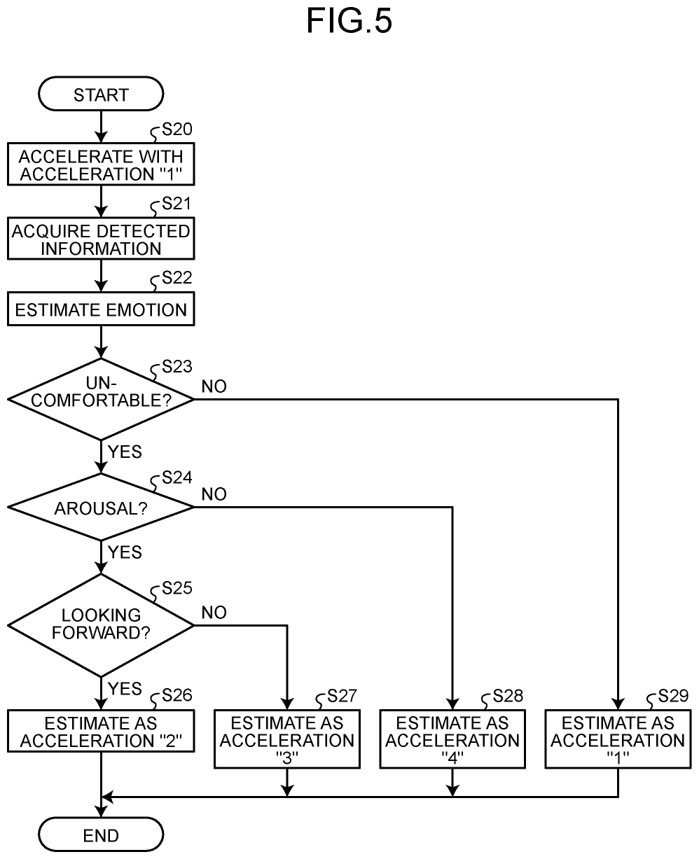

FIG. 5 is a flowchart showing an outline of a process performed by the driving support apparatus 40 according to the third embodiment. In the following description, the processing that the driving support apparatus 40 executes at each predetermined timing will be described when the vehicle 1 runs on the cruise control which maintains the speed at a constant automatically while following a predetermined distance between vehicles in front of the vehicle. Moreover, in FIG. 5, the Steps S20 to S22 correspond to the Steps S1 to S3 in FIG. 3.

In the Step S23, when the emotion estimation unit 41 estimates that the emotion of the occupant is uncomfortable (Step S23: Yes), the driving support apparatus 40 proceeds to the Step S24 described later. In contrast, when the emotion estimating unit 41 estimates that the emotion of the occupant is not uncomfortable (Step S23: No), the driving support apparatus 40 proceeds to the Step S29 described later.

Next, a case where the emotion estimating unit 41 estimates in Step S24 that the emotion of the occupant is changed from the sleeping state to the arousal state (Step S24: Yes) and that the occupant is looking forward of the vehicle 1 in the running direction (Step S25: Yes) will be described. In this case, the control parameter estimating unit 42 estimates the acceleration of the vehicle 1 as the acceleration “2” (Step S26). Specifically, the control parameter estimation unit 42 estimates a control parameter that becomes an acceleration “2” at which the emotion of the occupant becomes comfortable in order to induce the occupant to a sleeping state again when the occupant is in an arousal state (an awake state) in a state where the occupant is looking forward, for example, in a state where the face is directed in the same direction as the traveling direction of the vehicle 1. In this case, the driving control unit 43 accelerates the vehicle 1 such that the acceleration of the vehicle 1 becomes the acceleration “2” by controlling the driving unit 20 in accordance with the control parameter input from the control parameter estimating unit 42. After Step S26, the driving support apparatus 40 ends the process.

In Step S24, a case where the emotion estimating unit 41 estimates that the emotion of the occupant is changed from the sleeping state to the arousal state (Step S24: Yes) and that the occupant is not looking forward of the vehicle 1 in the running direction (Step S25: No) will be described. In this case, the control parameter estimating unit 42 estimates the acceleration of the vehicle 1 as the acceleration “3” (Step S27). Specifically, the control parameter estimating unit 42 estimates a control parameter that becomes an acceleration “3” in which emotion of an occupant becomes comfortable, in order to induce a sleeping state again, when a state in which the occupant does not see the front, for example, a state in which the face is directed to the side in a direction perpendicular to the running direction of the vehicle 1, and becomes an arousal state (an awake state). In this case, the driving control unit 43 accelerates the vehicle 1 such that the acceleration of the vehicle 1 becomes the acceleration “3” by controlling the driving unit 20 in accordance with the control parameter input from the control parameter estimating unit 42. After Step S2⁷, the driving support apparatus 40 ends the process.

In Step S24, a case where the emotion estimating unit 41 estimates that the emotion of the occupant is not changed from the sleeping state to the arousal state (Step S24: No) will be described. In this case, the control parameter estimating unit 42 estimates the acceleration of the vehicle 1 as the acceleration “4” (Step S28). Specifically, the control parameter estimating unit 42 estimates a control parameter that becomes an acceleration “4” having an acceleration larger than the acceleration “2” or the acceleration “3” because there is a low possibility of awakening even if the acceleration is increased since the occupant is in the sleeping state. That is, the magnitude of the acceleration is represented by the acceleration “1”, the acceleration “4”, the acceleration “2” and the acceleration “3” in this order. In this case, the driving control unit 43 accelerates the vehicle 1 such that the acceleration of the vehicle 1 becomes the acceleration “4” by controlling the driving unit 20 in accordance with the control parameter input from the control parameter estimating unit 42. After Step S28, the driving support apparatus 40 ends the process.

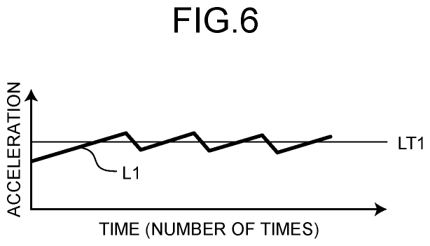

FIG. 6 is a diagram showing a relationship between acceleration of the vehicle 1 and time. In FIG. 6, the horizontal axis represents time (the number of times), and the vertical axis represents the acceleration. Moreover, in FIG. 6, the threshold LT1 indicates the level of the acceleration at which the occupant awakes. Furthermore, in FIG. 6, the polygonal line L1 shows the chronological change of the accelerations.

The driving support apparatus 40 causes the occupant in the sleeping state to repeat the sleeping state and the arousal state in accordance with the change in the acceleration. For this reason, when the emotion estimating unit 41 estimates that the occupant is in the arousal state as illustrated in the broken line L1 of FIG. 6, the control parameter estimating unit 42 estimates one of the acceleration “2” and the acceleration “3” that quickly reduce the acceleration from the threshold LT1 in order to induce the occupant to fall asleep. That is, the control parameter estimating unit 42 estimates the control parameter corresponding to one of the acceleration “2” and the acceleration “3” which greatly decrease the acceleration of the acceleration “1”.

In contrast, as illustrated in a broken line L1 of FIG. 6, when the occupant is estimated to be in the sleeping state by the emotion estimation unit 41, the acceleration “4” is estimated to bring the acceleration closer to the threshold LT1. That is, the control parameter estimation unit 42 estimates the control parameter corresponding to the acceleration “4” which is greater than the acceleration of the acceleration “2” or the acceleration “3”.

This allows the occupant to spend optimally in the cabin even if the sleeping and the arousal states are repeated.

Returning to FIG. 5, the explanation will continue the process after Step S29. In the Step S29, the control parameter estimating unit 42 estimates the acceleration of the vehicle 1 as acceleration “1” (Step S29). After Step S29, the driving support apparatus 40 ends the process.

According to the third embodiment described above, the control parameter estimating unit 42 estimates the control parameter corresponding to the arousal state or the sleeping state of the occupant's emotion estimated by the emotion estimating unit 41. This allows the occupant to spend optimally in the cabin even if the sleeping and the arousal states are repeated.

Next, a fourth embodiment is explained. In the fourth embodiment, the acceleration at which the occupant does not become the arousal state from the sleeping state is estimated chronologically, and the acceleration is sequentially reflected in the automatic driving. The configuration of the driving support apparatus according to the fourth embodiment is the same as the driving support apparatus 40 according to the first embodiment. In the following, the process performed by the driving support apparatus according to the fourth embodiment is explained.

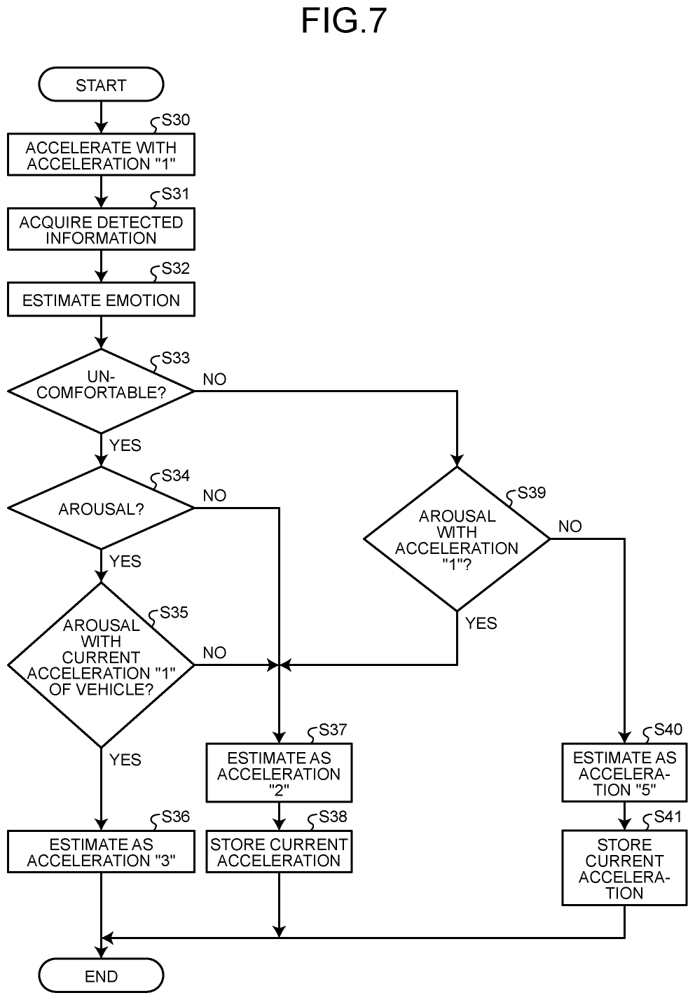

FIG. 7 is a flowchart showing an outline of the process performed by the driving support apparatus 40 according to the fourth embodiment. In the following description, the processing that the driving support apparatus 40 executes at each predetermined timing will be described when the vehicle 1 runs on the cruise control which maintains the speed at a constant automatically while following a predetermined distance between vehicles in front of the vehicle. In FIG. 7, the Steps S30 to S32 correspond to the Steps S1 to S3 of FIG. 3, respectively.

In Step S33, when the emotion estimation unit 41 estimates that the emotion of the occupant is uncomfortable (Step S33: Yes), the driving support apparatus 40 proceeds to Step S34. In contrast, when the emotion estimation unit 41 estimates that the emotion of the occupant is not uncomfortable (Step S33: No), the driving support apparatus 40 proceeds to Step S39.

In Step S34, when the emotion estimating unit 41 estimates that the emotion of the occupant is changed to the arousal state from the sleeping state (Step S34: Yes), the driving support apparatus 40 proceeds to Step S35 described later. In contrast, when the emotion estimation unit 41 estimates that the emotion of the occupant is not changed to the arousal state from the sleeping state (Step S34: No), the driving support apparatus 40 proceeds to Step S37 described later.

In Step S35, when the emotion estimation unit 41 estimates that the emotion of the occupant is changed to the arousal state from the sleeping state by the current acceleration “1” of the vehicle 1 (Step S35: Yes), the driving support apparatus 40 proceeds to Step S36 described later. In contrast, when the emotion estimation unit 41 estimates that the emotion of the occupant is not changed to the arousal state from the sleeping state by the current acceleration “1” of the vehicle 1 (Step S35: No), the driving support apparatus 40 proceeds to Step 337 described later.

In Step S36, the control parameter estimation unit 42 estimates the acceleration of the vehicle 1 as the acceleration “3”. Specifically, the control parameter estimation unit 42 estimates the control parameter for adjusting the acceleration at which the emotion of the occupant becomes comfortable and is smaller than the acceleration “2” because the emotion of the occupant is changed to the arousal state from the sleeping state and is uncomfortable. The control parameters are output from the control parameter estimation unit 42 to the driving control unit 43. The driving control unit 43 accelerates the vehicle 1 to the acceleration “3” by controlling the driving unit 20 in accordance with the control parameter input from the control parameter estimating unit 42. After Step S36, the driving support apparatus 40 ends the process.

In Step S37, the control parameter estimation unit 42 estimates the acceleration of the vehicle 1 as the acceleration “2”. Specifically, the control parameter estimating unit 42 estimates the control parameter for adjusting the acceleration smaller than the acceleration “1”, which is the acceleration at which the emotion of the occupant becomes comfortable because the emotion of the occupant is the sleeping state but is uncomfortable. The control parameters are output from the control parameter estimation unit 42 to the driving control unit 43. The driving control unit 43 accelerates the vehicle 1 to the acceleration “2” by controlling the driving unit 20 in accordance with the control parameter input from the control parameter estimating unit 42.

Subsequently, the control parameter estimation unit 42 updates the current acceleration corresponding to the control parameter of Step S37 to the control parameter corresponding to the acceleration “1” and stores it in the storage unit 30 (Step S38). After Step S38, the driving support apparatus 40 ends the process.

In Step S39, when the emotion estimation unit 41 estimates that the emotion of the occupant is changed to the arousal state from the sleeping state by the current acceleration “1” of the vehicle 1 (Step S39: Yes), the driving support apparatus 40 proceeds to Step S37. In contrast, when the emotion estimation unit 41 estimates that the emotion of the occupant is not changed to the arousal state from the sleeping state by the current acceleration “1” of the vehicle 1 (Step S39: No), the driving support apparatus 40 proceeds to Step S40 described later.

In Step S40, the control parameter estimation unit 42 estimates the acceleration of the current acceleration “1” as the acceleration “5” which is larger than the acceleration “1”. Specifically, the control parameter estimation unit 42 outputs the control parameter for adjusting the acceleration of the acceleration of the current acceleration “1” to the acceleration “5” which is larger than the acceleration “1” to the driving control unit 43 because the occupant is not awakened at the current acceleration of the vehicle 1 in the sleeping state.

Subsequently, the control parameter estimation unit 42 updates the current acceleration corresponding to the control parameter of Step S37 to the control parameter corresponding to the acceleration “5” and stores it in the storage unit 30 (Step S41). After Step S41, the driving support apparatus 40 ends the process.

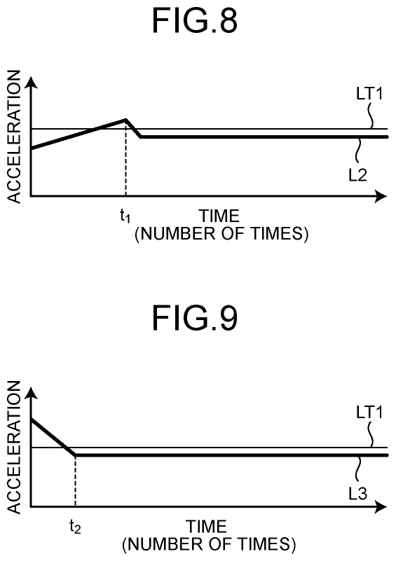

FIG. 8 and FIG. 9 are diagrams showing the relationship between acceleration and time of the vehicle 1. In FIG. 8 and FIG. 9, the horizontal axis represents time (the number of times), and the vertical axis represents acceleration. Moreover, in FIG. 8 and FIG. 9, the threshold LT1 indicates the level of the acceleration at which the occupant is awaken. Furthermore, the polygonal line L2 in FIG. 8 shows the chronological change of the accelerations. The polygonal line L3 in FIG. 9 shows the chronological change of the accelerations.

As illustrated in the line L2 of FIG. 8, when the acceleration exceeds LT1 (time t1), the occupant is in the arousal state from the sleeping state. For this reason, in Step S40, the control parameter estimating unit 42 estimates the control parameter that increases the acceleration chronologically until the occupant is estimated from the sleeping state to the arousal state by the emotion estimating unit 41.

In contrast, as illustrated in the broken line L2 of FIG. 9, when the acceleration is equal to or less than LT1 (time t2), the occupant is easily induced from the arousal state to the sleeping state. For this reason, in Step S37, the control parameter estimating unit 42 estimates a control parameter in which the acceleration is gradually decreased over time until the occupant is estimated from the arousal state to the sleeping state by the emotion estimating unit 41. That is, in Step S37, the control parameter estimation unit 42 estimates the control parameter for adjusting the acceleration to be acceleration in which the emotion of the occupant becomes comfortable and which is smaller than the acceleration “1” because the emotion of the occupant is the sleeping state but is uncomfortable.

According to the fourth embodiment described above, the control parameter estimating unit 42 estimates the control parameter corresponding to the optimum acceleration according to the current emotion of the occupant estimated by the emotion estimating unit 41. This allows the occupant to spend optimally in the cabin without waking, even in a sleeping state.

In the first to fourth embodiments, the emotion estimation unit estimates the emotion of one occupant, but the emotion may be estimated for all the occupants in the vehicle cabin. In this case, the emotion estimation unit may estimate the emotion of the occupant in the vehicle cabin from the average value or the maximum value of the detection information of the occupants.

Further, in the first to fourth embodiments, the driving support apparatus is provided in the vehicle, but the function of the driving support apparatus may be realized by one server. In addition, the emotion estimation unit, the control parameter estimation unit and the driving control unit that constitute the driving support apparatus may be realized by a plurality of servers.

Further, in the driving support apparatus according to the first to fourth embodiments, the above-described “unit” may be read as “means” or “circuit” or the like. For example, the emotion estimation unit may be read as emotion estimation means or an emotion estimation circuit.

Further, the program executed by the driving support apparatus according to the first to fourth embodiments is stored and provided in a computer-readable recording medium such as a CD-ROM, a flexible disk (FD), a CD-R, a DVD (Digital Versatile Disk, a USB medium, or a flash memory in the form of a file data that may be installed or executed.

In the explanations of the flowcharts in this specification, it has been clarified the order of the processing using expressions such as “first”, “thereafter”, “following” etc., the order of the processing necessary for carrying out the present disclosure may not be limited by the expressions. That is, the order of processing in the flowcharts may be varied to the extent that there is no discrepancy.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A driving support apparatus comprising
a processor configured to:
obtain biometric information for at least one occupant on a vehicle;
estimate emotion of the occupant based on the biological information;
control acceleration of the vehicle based on the estimated emotion of the occupant.

2. The driving support apparatus according to claim 1, wherein
the emotion is one of discomfort and comfort, and
the processor is configured to reduce the acceleration of the vehicle when the estimated emotion of the occupant is uncomfortable.

3. The driving support apparatus according to claim 2, wherein the processor is configured to:
obtaining gaze information about an eye of the occupant;
estimate the emotion of the occupant based on the gaze information and the biological information.

4. The driving support apparatus according to claim 3, wherein the processor is configured to:
further estimate, as the emotion, an arousal state and sleeping state of the occupant; and
reduce the acceleration of the vehicle when the estimated emotion of the occupant changes from the sleeping state to the arousal state and is uncomfortable.

5. The driving support apparatus according to claim 4, wherein the processor is configured to reduce the acceleration of the vehicle stepwise until the estimated emotion of the occupant becomes comfortable from uncomfortable.

6. The driving support apparatus according to claim 5, wherein the processor is configured to set the acceleration of the vehicle for each occupant.

7. The driving support apparatus according to claim 5, wherein the processor is configured to estimate the emotion of the occupant during automatic driving of the vehicle.
